(19) United States
(12) Patent Application Publication
(10) Pub. No.: US 2026/0285750 A1
(43) Pub. Date: Sep. 24, 2026

(54) COMPOSITIONS AND METHODS OF MAKING CEMENTITIOUS BINDERS VIA CARBONATION

(71) Applicant: C-CRETE TECHNOLOGIES LLC, San Leandro, CA (US)

(72) Inventors: Rouzbeh SAVARY, San Leandro, CA (US); Sanan EMINOV, San Leandro, CA (US)

(21) Appl. No.: 19/474,451

(22) PCT Filed: Apr. 10, 2024
(86) PCT No.: PCT/US2024/023831

§ 371 Date: Oct. 10, 2025

Related U.S. Application Data
(60) Provisional application No. 63/458,366, filed on Apr. 10, 2023.

(51) Int. Cl. C04B 14/28; C04B 14/06; C04B 41/00; C04B 103/00; C04B 103/10; C04B 103/30; C04B 103/32

(52) U.S. Cl. CPC C04B 14/28; C04B 14/06; C04B 41/009; C04B 2103/0096; C04B 2103/10; C04B 2103/302; C04B 2103/32

(57) ABSTRACT

A carbonatable-based cementitious material may include a carbonatable material comprising magnetite (Fe3O4), hematite (Fe2O3), siderite (FeCO3), geothite (FeO(OH)), ilmenite (FeTiO), limonite (FeO(OH)) nH2O, FeS2 (Pyrite), Obsidian (Volcanic Glass), iron powder, heterosite, bernalite, greenalite, cubanite, annite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag, zinc and lead slag, wollastonite and pseudowollastonite formed through sintering of limestone and sand, or combinations thereof. A carbonatable-based cementitious material may include a reducing agent. A carbonatable-based cementitious material may include an uncarbonatable material comprising sand, gravel, or combinations thereof. A carbonatable-based cementitious material may include one or more admixtures.

### CROSS-REFERENCE TO RELATED APPLICATIONS

This application claims the priority benefit of U.S. Provisional Application No. 63/458,366 filed on Apr. 10, 2023, the entirety of which is incorporated by reference herein.

### BACKGROUND

Cementitious materials are crucial components in building materials and other industries. One of the most common cementitious materials is Portland cement. Despite its widespread use, there are environmental concerns surrounding Portland cement, including the emission of greenhouse gases and significant energy requirements during production. Accordingly, there is a desire to provide cementitious materials which have a smaller environmental footprint.

### SUMMARY

In some aspects, the techniques described herein relate to a carbonatable-based cementitious material including: a carbonatable material including magnetite (Fe₃O₄), hematite (Fe₂O₃), siderite (FeCO₃), geothite (FeO(OH)), ilmenite (FeTiO), limonite (FeO(OH))nH₂O, FeS₂ (Pyrite), Obsidian (Volcanic Glass), iron powder, heterosite, bernalite, greenalite, cubanite, annite, electric arc furnace slag (EAF), reducing steel slag, oxidizing steel slag, converter steel slag, basic oxygen furnace slag, ladle slag, slow or fast cooled steel slag, ground granulated blast furnace slag (GGBFS), air-cooled slag, copper slag, Solvay slag phosphorous slag, bauxite slag, zinc and lead slag, mine tails, wollastonite and pseudowollastonite formed through the sintering of limestone and sand, or combinations thereof; a reducing agent; an uncarbonatable material including sand, gravel, or combinations thereof; and one or more admixtures.

In some aspects, the techniques described herein relate to a carbonatable-based cementitious material, further including ordinary Portland cement, limestone, zeolite, fly ash, clay, calcined clay, granite, basalt, cement kiln dust, pumice, volcanic tuff, volcanic lava, biomass ash, municipal solid waste incineration ashes, or combinations thereof.

In some aspects, the techniques described herein relate to a carbonatable-based cementitious material, wherein carbonation of the carbonatable material results in the formation one or more phases of metal carbonates including FeCO₃, CaCO₃, MgCO₃, or combinations thereof.

In some aspects, the techniques described herein relate to a carbonatable-based cementitious material, wherein the carbonatable material is curable by CO₂ gas through a carbonation reaction, wherein the CO₂ gas is a gas stream including direct air capture, flue gas, industrial CO₂, or combinations thereof, wherein the gas stream includes at least 0.03% CO₂ or dilute CO₂ contained in air.

In some aspects, the techniques described herein relate to a carbonatable-based cementitious material, wherein the carbonatable material is carbonated at a temperature of about 25° C. to about 200° C.

In some aspects, the techniques described herein relate to a carbonatable-based cementitious material, wherein the carbonatable material is carbonated at a pressure of about 1 psi to about 200 psi.

In some aspects, the techniques described herein relate to a carbonatable-based cementitious material, wherein the reducing agent is present and includes iron, lithium, carbon, hydrogen, iron impurities, coal, carbon black, activated carbon, iron-containing materials, carbon-containing materials, or combinations thereof.

In some aspects, the techniques described herein relate to a carbonatable-based cementitious material, wherein the reducing agent is present in amount of about 0% to about 15% of the carbonatable-based cementitious material.

In some aspects, the techniques described herein relate to a carbonatable-based cementitious material, wherein the carbonatable material is cured in a water vapor environment, wherein the water vapor environment includes pure water, alkali water, a solution of alkali metal salts in water, a solution of alkali metal oxides in water, or combinations thereof.

In some aspects, the techniques described herein relate to a carbonatable-based cementitious material, wherein the carbonatable-based cementitious material has a mass gain of at least 1% or more by weight of the carbonatable material.

In some aspects, the techniques described herein relate to a carbonatable-based cementitious material, wherein the admixture includes a pH-regulating admixture and is present in amount of 0.1% to 10% by weight of the carbonatable material, and includes one or more of ammonia, amines, sodium silicate, ordinary Portland cement (OPC), and recycled high alkalinity concrete, alkali hydroxides, alkali earth hydroxides, alkali carbonate, alkali earth carbonates, alkali metal oxides, alkali earth metal oxides, alkali bicarbonates, and alkali earth bicarbonates such as NaOH, KOH, Mg(OH)₂, Ca(OH)₂, Na₂CO₃, K₂CO₃, MgCO₃, NaHCO₃, KHCO₃, MgO, and CaO.

In some aspects, the techniques described herein relate to a carbonatable-based cementitious material, wherein the admixture includes a curing enhancer or accelerator admixture and is present in an amount of about 0.1% to about 10% by weight of the carbonatable material, and includes one or more of alkali metal oxides solubilized in acetic acid, acetic acid solution, alkaline hydroxide solutions, and alkali salt solutions.

In some aspects, the techniques described herein relate to a carbonatable-based cementitious material, wherein the admixture reduces agglomeration of the carbonatable material and is present in an amount of about 0.1% to about 10% by weight of the carbonatable material, and includes one or more of carbon black, sand, gravel, and soluble alkali metal salts.

In some aspects, the techniques described herein relate to a carbonatable-based cementitious material, wherein the admixture includes a water-reducing admixture and is present in an amount of about 0.1% to about 5% by weight of the carbonatable material, and includes a plasticizer, a superplasticizer polymer, or combinations thereof.

In some aspects, the techniques described herein relate to a carbonatable-based cementitious material, wherein the carbonatable material is premixed in water and then mixed with the one or more admixtures, wherein the one or more admixtures are premixed in water and mixed with the carbonatable material, or wherein the carbonatable material and the one or more admixtures are first combined and subsequently mixed with water.

In some aspects, the techniques described herein relate to a carbonatable-based cementitious material, where in the one or more admixtures include a combination of two or more of a pH regulating admixture, a curing enhancer, an agglomeration reducer, a water-reducing admixture, a retarder, a corrosion inhibitor, a shrinkage reducer, a crack reducer, an air entrainer, a viscosity modifier, or combinations thereof.

In some aspects, the techniques described herein relate to a carbonatable-based cementitious material, wherein the carbonatable material, the reducing agent, the uncarbonatable material, and the one or more admixtures are milled before exposure to CO₂.

In some aspects, the techniques described herein relate to a carbonatable-based cementitious material, wherein the carbonatable-based cementitious material has a compressive strength of at least 1000 psi when cured.

In some aspects, the techniques described herein relate to a composite material including the carbonatable-based cementitious material of any of the previous claims, and one or more aggregates.

In some aspects, the techniques described herein relate to a cement composition, including water and the carbonatable-based cementitious material of any of the previous claims, wherein the ratio of water to carbonatable-based cementitious material is at least 0.15.

In some aspects, the techniques described herein relate to a method of carbonating a carbonatable material which includes iron ore, steel slag, or any other iron and iron oxide containing material, the method including using a reducing agent which includes carbon or iron to thereby make cementitious binders via formation of FeCO₃, CaCO₃, MgCO₃, or combinations thereof.

In some embodiments, there is provided a method of preparing a carbonatable-based cementitious material, including: combining a carbonatable material, a reducing agent, an uncarbonatable material, and one or more admixtures, thereby forming the carbonatable-based cementitious material.

In some embodiments of the method, the carbonatable material includes magnetite (Fe₃O₄), hematite (Fe₂O₃), siderite (FeCO₃), geothite (FeO(OH)), ilmenite (FeTiO), limonite (FeO(OH))nH₂O, FeS₂ (Pyrite), Obsidian (Volcanic Glass), iron powder, heterosite, bernalite, greenalite, cubanite, annite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag, zinc and lead slag, wollastonite and pseudowollastonite formed through sintering of limestone and sand, or combinations thereof.

In some embodiments of the method, the reducing agent is present includes iron, lithium, carbon, hydrogen, iron impurities, coal, carbon black, activated carbon, iron-containing or carbon-containing materials, or combinations thereof. In some embodiments of the method, the uncarbonatable material includes sand, gravel, or combinations thereof. In some embodiments of the method, the one or more admixtures comprise a pH regulating admixture, a curing enhancer, an agglomeration reducer, a water-reducing admixture, a retarder, a corrosion inhibitor, a shrinkage reducer, a crack reducer, an air entrainer, a viscosity modifier, or combinations thereof. In some embodiments of the method, the one or more of the carbonatable material, the reducing agent, the uncarbonatable material, and the one or more admixtures are milled for a time of about 0.1 hour to about 50 hours.

In some embodiments of the method, the carbonatable material is thermally treated at a temperature of about 25° C. to about 1000° C. In some embodiments of the method, the carbonatable material is cured with CO₂. In some embodiments of the method, curing the carbonatable material with CO₂ is performed at a temperature of about 25° C. to about 200° C. In some embodiments of the method, curing the carbonatable material with CO₂ is performed at a pressure of about 1 psi to about 200 psi. In some embodiments of the method, curing the carbonatable material with CO₂ is performed at a temperature of about 25° C. to about 200° C. and a pressure of about 1 psi to about 200 psi.

### DETAILED DESCRIPTION

Provided herein are carbonatable-based cementitious materials. The carbonatable-based cementitious materials may include a carbonatable material comprising magnetite (Fe₃O₄), hematite (Fe₂O₃), siderite (FeCO₃), geothite (FeO(OH)), ilmenite (FeTiO), limonite (FeO(OH))nH₂O, FeS₂ (Pyrite), Obsidian (Volcanic Glass), iron powder, heterosite, bernalite, greenalite, cubanite, annite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag, zinc and lead slag, wollastonite and pseudowollastonite formed through the sintering of limestone and sand, or combinations thereof; a reducing agent; an uncarbonatable phase comprising sand, gravel, or combinations thereof; and one or more admixtures.

In some embodiments, the carbonatable-based cementitious material further includes ordinary Portland cement, limestone, zeolite, fly ash, clay, calcined clay, granite, basalt, cement kiln dust, mumice, volcanic tuff, volcanic lava, biomass, municipal solid waste incineration (MSWI) ash, or combinations thereof. In some embodiments, the carbonatable material and/or the uncarbonatable material are in the form of grains. In some embodiments as described herein, the reducing agent may be omitted, such that the carbonatable-based cementitious material includes a carbonatable material as described herein, an uncarbonatable material as described herein, and one or more admixtures as described herein. In some embodiments as described herein, the carbonatable-based cementitious material includes only a carbonatable material as described herein.

Such carbonatable-based cementitious material may include carbonatable iron containing materials, calcium silicate, slag-based materials and concrete products that contain one or more admixtures. Methods of preparing carbonatable iron, calcium silicate, slag-based materials and concrete that contain one or more admixtures are also described herein.

The present disclosure provides methods and compositions for creating cementitious binders using carbonatable iron ore-based, slag-based, and calcium silicate based materials. The carbonatable material compositions may in some embodiments include one or more admixtures to improve certain properties, without wishing to be bound by theory. The carbonatable iron ore, slag, and calcium silicate based material preparation includes different physical and chemical methods which may improve various properties. The improved properties may include chemical, physical, and aesthetic properties, such as stability with acid and bases, strength, durability, color, and the like. Moreover, one or more admixtures or different composition of admixture combinations may be used to improve the curing of carbonatable materials.

In some embodiments, the carbonatable material above includes water for molding. The water binder ratio can be about 0.10 to about 0.50.

The carbonatable materials described herein can be cured and hardened with CO₂ gas through a carbonation reaction. The CO₂ gas can be any source such as direct air capture, flue gas, industrial CO₂ and the like which contain at least 1% CO₂. In some embodiments, curing with CO₂ containing streams such as flue gas does not require separation of pure CO₂ from the rest of the stream.

All of the carbonatable materials described herein can be cured with CO₂ gas through the carbonation reaction at a temperature of about 25° C. to about 200° C. to form different carbonates.

The carbonatable materials as described herein may be cured in a water vapor environment to improve the carbonation. The vapor environment can be composed of pure water or alkali water or solution of alkali metal salts or solution of alkali metal oxide, or combinations thereof.

The carbonatable-based cementitious materials as described herein may have a mass gain of 1% or more by weight of the carbonatable material (due to carbonation).

The components of the carbonatable-based cementitious materials as described herein may be milled individually or together, and the milling of the carbonatable material may be performed for about 0 minutes to 10 hours. Milling can be performed with ball mill, tower mill, pebble mill, high pressure grinding rolls, autogenous mill, rod mill, and the like, or combinations thereof.

The carbonatable-based cementitious materials may include a reducing agent for the carbonation reaction which may include different metals and nonmetals such as iron, lithium, carbon, hydrogen, iron impurities, coal, and the like. The reducing agent may be present in amount of about 0% to 15% of the carbonatable material.

The carbonatable-based cementitious materials may include a pH-regulating admixture, which is present in amount of about 0.01% to about 10% of the carbonatable material, and may include alkali hydroxides, alkali earth hydroxides, alkali carbonate, alkali earth carbonates, alkali metal oxides, alkali earth metal oxides, alkali bicarbonates, alkali earth bicarbonates, ammonia, amines, sodium silicate, ordinary Portland cement (OPC), recycled high alkalinity concrete, and combinations thereof.

The carbonatable-based cementitious materials may include an admixture, and the admixture may include a curing enhancer or accelerator admixture, and is present in an amount of about 0.01% to about 10% of the carbonatable material. The curing enhancer or accelerator admixture may include alkali metal oxides solubilized in acetic acid, acetic acid solution, alkaline hydroxide solutions, and alkali salt solutions.

The carbonatable-based cementitious materials may include an admixture, wherein the admixture may reduce agglomeration of carbonatable material for better carbonation and is present in an amount of 0.01% to 10% of the carbonatable material, and may include one or more of carbon black, sand, gravel, and soluble alkali metal salts, or combinations thereof.

The carbonatable-based cementitious materials may include an admixture, wherein the admixture may include a water-reducing admixture, and is present in an amount of 0.01% to 5% of the carbonatable material, and may include plasticizers, superplasticizer polymers, or combinations thereof.

The carbonatable-based cementitious materials of the present disclosure may include an admixture, wherein the admixture may include a combination of two or more of a pH regulating admixture, a curing enhancer, an agglomeration reducer, a water-reducing admixture, a retarder, a corrosion inhibitor, a shrinkage reducer, a crack reducer, an air entrainer, and a viscosity modifier.

The carbonatable-based cementitious materials of the present disclosure can, in some embodiments, be formed such that the admixtures can be premixed in water and then added to the carbonatable material as a single liquid, or the carbonatable material can be premixed in water and then the admixtures can be added and mixed with the premixed carbonatable material.

There is provided a composite material made from carbonatable materials as described herein, further including one or more fillers.

The carbonatable-based cementitious materials of the present disclosure may include a second carbonatable material, wherein the second carbonatable material may include one or more combinations of alkali hydroxides, alkali earth hydroxides, alkali carbonate, alkali earth carbonates, alkali metal oxides, alkali earth metal oxides, alkali bicarbonates, alkali earth bicarbonates, ammonia, amines, sodium silicate, ordinary Portland cement (OPC), and recycled high alkalinity concrete.

In some embodiments, the particle size of the carbonatable materials and the admixtures are fine and extra-fine to improve the surface area for better reactivity thus increasing the strength, durability, and other properties, without wishing to be bound by theory.

As described herein, “carbonatable material” refers to a material that can be cured with carbon dioxide (CO₂) gas through a carbonation reaction. Once cured with CO₂, it is called “carbonated”. The carbon dioxide gas can be in different forms such as CO₂ in vapor form, CO₂ in the presence of water, CO₂ from carbonic acid, or in other forms which is suitable for the carbonation reaction. The CO₂ gas may be a gas stream comprising direct air capture, flue gas, industrial CO₂, or combinations thereof, wherein the gas stream comprises at least 0.03% CO₂. The CO₂ gas used in the compositions described herein can be pure CO₂ or may contain various impurities or may be dilute CO₂ such as flue gas or CO₂ in air.

In some embodiments, the carbonatable material is already carbonated and is heated to about 400° C. to yield metal oxide for carbonation. In certain embodiments, the carbonatable material is already carbonated and is heated to about 600° C. to yield metal oxide for carbonation. In certain embodiments, the carbonatable material is already carbonated and is heated to about 800° C. to yield metal oxide for carbonation. In certain embodiments, the carbonatable material is already carbonated and it is heated to about 1000° C. to yield metal oxide for carbonation.

In certain embodiments, the carbonatable-based cementitious material includes a reducing agent for the carbonation reaction. The reducing agent may include iron, lithium, carbon, hydrogen, iron impurities, coal, carbon black, activated carbon, iron-containing materials, carbon-containing materials, and the like, as familiar to those of ordinary skill in the art. In certain embodiments, the reducing agent is present in amounts of about 0% to about 15% by weight of the carbonatable-based cementitious material.

The carbonation of the carbonatable material can occur in the presence of CO₂. In some embodiments, representative chemical equations are:

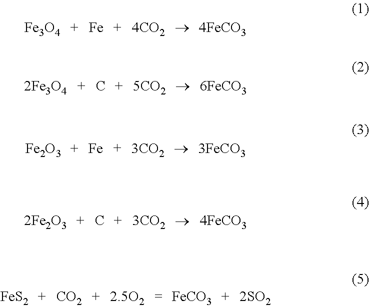

In some embodiments, the carbonation of the carbonatable material must be first treated with heat (and/or oxygen) to produce intermediate Fe₂O₃ as shown in Equations (6-8) and then the rest of the carbonation follows Equation (3) and (4).

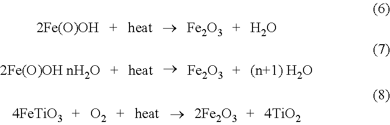

The carbonation of a calcium silicate material can occur in the presence of CO₂ according to the equation (9) below:

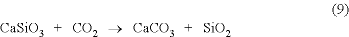

The carbonation of a slag-based material can occur through the reaction of metal oxides in the presence of CO₂ according to the equation (10) below:

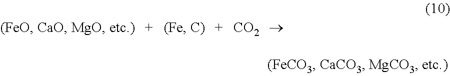

In some embodiments, carbonation of the carbonatable material results in the formation one or more phases of metal carbonates such as FeCO₃, CaCO₃, and MgCO₃, and the like, denoting that more CO₂ will be captured with metal oxides not limited to Ca and Mg oxides only, without wishing to be bound by theory.

The carbonatable material described herein may have a mean particle size of about 1 μm to about 10 μm, about 1 μm to about 20 μm, about 1 μm to about 50 μm, about 1 μm to about 100 μm, about 1 μm to about 150 μm, about 1 μm to about 200 μm, or any range or value contained therein. The admixtures described herein may have a mean particle size of about 1 μm to about 10 μm, about 1 μm to about 20 μm, about 1 μm to about 50 um μm about 1 μm to about 100 μm, about 1 μm to about 150 μm, about 1 μm to about 200 μm, or about 1 μm to about 1000 um μm or any range or value contained therein. In certain embodiments, the reducing agent has a mean particle size of about 1 μm to about 10 μm, about 1 μm to about 20 μm, about 1 μm to about 50 μm, about 1 μm to about 100 μm, about 1 μm to about 150 μm, about 1 μm to about 200 μm, or any range or value contained therein.

In certain embodiments, one or more of the carbonatable material, the reducing agent, the uncarbonatable phase, and the admixture are milled before exposure to CO₂. In some embodiments, the milling time of the carbonatable materials and admixtures are about 0 to about 5 hours. In certain embodiments, the milling time of the mixture is about 0 to about 10 hours. In certain embodiments, the milling time of the mixture is about 0 to about 20 hours. In certain embodiments, the milling time of the mixture is about 0 to about 30 hours. In certain embodiments, the milling time of the mixture is about 0 to about 40 hours. In certain embodiments, the milling time of the mixture is about 0 to about 50 hours, or any range or value contained therein.

In certain embodiments, the mass ratio of carbonatable material to the one or more admixtures is more than 2, such as from about 2 to about 5. In certain embodiments, this ratio is about from 2 to 10. In certain embodiments, this ratio is about from 2 to 15. In certain embodiments, this ratio is from about 2 to about 200.

In certain embodiments, the mass ratio of the reducing agent to the carbonatable material is more than about 0.05, such as from about 0.05 to 0.1. In certain embodiments, this ratio is about from 0.05 to 0.2. In certain embodiments, this ratio is about from 0.05 to 0.4. In certain embodiments this ratio is from about 0.05 to about 0.6.

In certain embodiments, the curing of the carbonatable material with CO₂ gas occurs at a pressure of at least about 1 psi, such as from about 1 psi to about 90 psi. In certain embodiments, the pressure is about from 1 psi to 200 psi. In certain embodiments, the is from about 1 psi to about 150 psi. In certain embodiments, the pressure is about from 1 psi to 200 psi.

In certain embodiments, the curing of the carbonatable material with CO₂ gas occurs at a temperature of at least 25° C., such as from about 25° C. to about 90° C. In certain embodiments, the temperature is about from 25° C. to 120° C. In certain embodiments, the temperature is about from 25° C. to 150° C. In certain embodiments, the temperature is about from 25° C. to 200° C.

The carbonatable-based cementitious material may include a carbonatable material as described herein and any suitable aggregates such as crushed stone, sand, recycled aggregate, granite, quartz, sand, limestone, construction sand, gravel, rocks, or combinations thereof. The mean particle size of the aggregate can be more than about 0.1 mm, such as from about 0.1 mm to about 30 mm. In certain embodiments, the mean particle size of the aggregate is about from 0.1 mm to 5 mm, about 0.1 mm to about 10 mm, about 0.1 mm to about 20 mm, about 0.1 mm to about 30 mm, or any range or value contained therein.

Provided herein are methods to prepare a carbonatable-based cementitious material. Such methods may result in the improvement of one or more properties of a carbonatable-based cementitious material, without wishing to be bound by theory. The methods described herein may include the addition of different admixtures and/or reducing agents, milling one or more of the components of the carbonatable-based cementitious material for a certain period of time, and/or curing with CO₂ at a certain temperature and pressure. In some embodiments, adding a reducing agent to a carbonatable material includes adding a solid reducing agent. In some embodiments, adding a reducing agent to the carbonatable material includes adding a liquid reducing agent. In some embodiments, adding a reducing agent to the carbonatable material includes adding a gas phase reducing agent. In some embodiments, adding an admixture to the carbonatable material includes adding a solid admixture. In some embodiments, adding an admixture to the carbonatable material includes adding a liquid admixture. In some embodiments, adding an admixture to the carbonatable material includes adding a mixture of solid and liquid admixtures. The methods provided herein can include a curing step with CO₂ gas to form a concrete product.

In some embodiments, there is provided a method of preparing a carbonatable-based cementitious material, including: combining a carbonatable material, a reducing agent, an uncarbonatable material, and one or more admixtures, thereby forming the carbonatable-based cementitious material.

In some embodiments of the method, the carbonatable material includes magnetite (Fe₃O₄), hematite (Fe₂O₃), siderite (FeCO₃), geothite (FeO(OH)), ilmenite (FeTiO), limonite (FeO(OH))nH₂O, FeS₂ (Pyrite), Obsidian (Volcanic Glass), iron powder, heterosite, bernalite, greenalite, cubanite, annite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag, zinc and lead slag, mine tails, wollastonite and pseudowollastonite formed through sintering of limestone and sand, or combinations thereof.

In some embodiments of the method, the reducing agent includes iron, lithium, carbon, hydrogen, iron impurities, coal, carbon black, activated carbon, iron-containing materials, carbon-containing materials, or combinations thereof. In some embodiments of the method, the uncarbonatable material includes sand, gravel, or combinations thereof. In some embodiments of the method, the one or more admixtures comprise a pH regulating admixture, a curing enhancer, an agglomeration reducer, a water-reducing admixture, a retarder, a corrosion inhibitor, a shrinkage reducer, a crack reducer, an air entrainer, a viscosity modifier, or combinations thereof. In some embodiments of the method, the one or more of the carbonatable material, the reducing agent, the uncarbonatable material, and the one or more admixtures are milled for a time of about 1 hour to about 50 hours.

In some embodiments of the method, the carbonatable material is thermally treated at a temperature of about 25° C. to about 1000° C. In some embodiments of the method, the carbonatable material is cured with CO₂. In some embodiments of the method, curing the carbonatable material with CO₂ is performed a temperature of about 25° C. to about 200° C. In some embodiments of the method, curing the carbonatable material with CO₂ is performed at a pressure of about 1 psi to about 200 psi. In some embodiments of the method, curing the carbonatable material with CO₂ is performed at a temperature of about 25° C. to about 200° C. and a pressure of about 1 psi to about 200 psi.

In certain embodiments, the carbonatable material is already carbonated and it is heated to about 400° C. to get metal oxide for carbonation. In certain embodiments, the carbonatable material is already carbonated and it is heated to about 600° C. to get metal oxide for carbonation. In certain embodiments, the carbonatable material is already carbonated and it is heated to about 800° C. to get metal oxide for carbonation. In certain embodiments, the carbonatable material is already carbonated and it is heated to about 1000° C. to get metal oxide for carbonation.

In some embodiments, more than one admixture is added, and in such embodiments the admixtures can be added in any or order. In certain embodiments, two or more admixtures can be added together as a mixture.

Provided herein are methods to improve one or more strength properties of the carbonatable material composition by adding admixtures or milling. Examples of strength properties that can be improved include compressive strength, torsional strength, split tensile strength, tensile strength, flexural strength, and combinations thereof.

Provided herein are methods to improve the properties of final products such as strength, CO₂ uptake, and other properties. Milling of the components in such methods is described herein. The milling time of the solid material may be, without wishing to be bound by theory, important for the effective curing with CO₂ and final properties.

Provided herein are methods to regulate the pH of the carbonatable-based cementitious material, by adding an admixture described herein. In some examples, the admixture is a pH-regulating admixture.

Provided herein are methods to enhance the curing of the carbonatable-based cementitious material, by adding an admixture described herein. In some examples, the admixture is a curing enhancer or curing accelerator admixture.

Provided herein are methods to reduce the agglomeration of the carbonatable-based cementitious material, by adding an admixture described herein. In some examples, the admixture is different fillers.

Provided herein are methods to reduce the water amount of the carbonatable-based cementitious material, by adding an admixture described herein. In some examples, the admixture is water-reducing admixture.

The carbonatable-based cementitious material as described herein may include an admixture, wherein the admixture may include a combination of two or more of a pH regulating admixture, a curing enhancer, an agglomeration reducer, a water-reducing admixture, a retarder, a corrosion inhibitor, a shrinkage reducer, a crack reducer, an air entrainer, and a viscosity modifier.

The carbonatable-based cementitious material as described herein may include embodiments wherein the carbonatable material is cured in water vapor environment to improve the carbonation, without wishing to be bound by theory. The vapor environment can include pure water, alkali water, solution of alkali metal salts, solution of alkali metal oxide, or combinations thereof.

In certain embodiments, the curing of the carbonatable material with CO₂ gas occurs at a pressure of at least 1 psi, such as from 1 psi to 90 psi. In certain embodiments it is about from 1 psi to 120 psi. In certain embodiments it is about from 1 psi to 150 psi. In certain embodiments it is about from 1 psi to 200 psi.

In certain embodiments, the curing of carbonatable material with CO₂ gas occurs at a temperature of at least 25° C., such as from 25° C. to 90° C. In certain embodiments it is about from 25° C. to 120° C. In certain embodiments it is about from 25° C. to 150° C. In certain embodiments it is about from 25° C. to 200° C.

In some embodiments, there is provided a method of carbonating a carbonatable material which includes iron ore or slag, the method includes using a reducing agent which includes carbon or iron to thereby make cementitious binders via the formation of FeCO₃, CaCO₃, MgCO₃, or combinations thereof.

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%.

The numerical values used in this disclosure are to be construed as being characterized by the above described “about”, are also intended to include the exact numerical values disclosed herein. The ranges disclosed here includes the upper and lower limits.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

1. A carbonatable-based cementitious material comprising:
a carbonatable material comprising magnetite (Fe₃O₄), hematite (Fe₂O₃), siderite (FeCO₃), geothite (FeO(OH)), ilmenite (FeTiO), limonite (FeO(OH))nH₂O, FeS₂ (Pyrite), Obsidian (Volcanic Glass), iron powder, heterosite, bernalite, greenalite, cubanite, annite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag, zinc and lead slag, mine tails, wollastonite and pseudowollastonite formed through sintering of limestone and sand, or combinations thereof;
a reducing agent;
an uncarbonatable material comprising sand, gravel, or combinations thereof; and
one or more admixtures.

2. The carbonatable-based cementitious material of claim 1, further comprising ordinary Portland cement, limestone, zeolite, fly ash, clay, calcined clay, granite, basalt, cement kiln dust, pumice, volcanic tuff, volcanic lava, biomass ash, municipal solid incineration waste incineration (MSWI) ash, or combinations thereof.

3. The carbonatable-based cementitious material of claim 1, wherein carbonation of the carbonatable material results in formation one or more phases of metal carbonates comprising FeCO₃, CaCO₃, MgCO₃, or combinations thereof.

4. The carbonatable-based cementitious material of claim 1, wherein the carbonatable material is curable by CO₂ gas through a carbonation reaction, wherein the CO₂ gas is a gas stream comprising direct air capture, flue gas, industrial CO₂, or combinations thereof, wherein the gas stream comprises at least 0.03% CO₂.

5. The carbonatable-based cementitious material of claim 1, wherein the carbonatable material is carbonated at a temperature of about 25° C. to about 200° C.

6. The carbonatable-based cementitious material of claim 1, wherein the carbonatable material is carbonated at a pressure of about 1 psi to about 200 psi.

7. The carbonatable-based cementitious material of claim 1, wherein the reducing agent is present and comprises iron, lithium, carbon, hydrogen, iron impurities, coal, carbon black, activated carbon, iron-containing or carbon-containing materials, or combinations thereof.

8. The carbonatable-based cementitious material of claim 1, wherein the reducing agent is present in amount of about 0% to about 15% of the carbonatable-based cementitious material.

9. The carbonatable-based cementitious material of claim 1, wherein the carbonatable material is cured in a water vapor environment, wherein the water vapor environment comprises pure water, alkali water, a solution of alkali metal salts in water, a solution of alkali metal oxides in water, or combinations thereof.

10. The carbonatable-based cementitious material of claim 1, wherein the carbonatable-based cementitious material has a mass gain of at least 1% or more by weight of the carbonatable material.

11. The carbonatable-based cementitious material of claim 1, wherein the one or more admixtures comprise a pH-regulating admixture and are present in an amount of 0.01% to 10% by weight of the carbonatable material, and comprises one or more of alkali hydroxides, alkali earth hydroxides, alkali carbonate, alkali earth carbonates, alkali metal oxides, alkali earth metal oxides, alkali bicarbonates, alkali earth bicarbonates, ammonia, amines, sodium silicate, ordinary Portland cement (OPC), and recycled high alkalinity concrete.

12. The carbonatable-based cementitious material of claim 1, wherein the one or more admixtures comprise a curing enhancer or accelerator admixture and are present in an amount of about 0.01% to about 10% by weight of the carbonatable material, and comprises one or more of alkali metal oxides solubilized in acetic acid, acetic acid solution, alkaline hydroxide solutions, and alkali salt solutions.

13. The carbonatable-based cementitious material of claim 1, wherein the one or more admixtures reduce agglomeration of the carbonatable material and is present in an amount of about 0.01% to about 10% by weight of the carbonatable material, and comprises one or more of carbon black, sand, gravel, and soluble alkali metal salts.

14. The carbonatable-based cementitious material of claim 1, wherein the one or more admixtures comprise a water-reducing admixture and is present in an amount of about 0.01% to about 5% by weight of the carbonatable material, and comprises a plasticizer, a superplasticizer polymer, or combinations thereof.

15. The carbonatable-based cementitious material of claim 1, wherein the carbonatable material is premixed in water and then mixed with the one or more admixtures, wherein the one or more admixtures are premixed in water and mixed with the carbonatable material, or wherein the carbonatable material and the one or more admixtures are first combined and subsequently mixed with water.

16. The carbonatable-based cementitious material of claim 1, wherein the one or more admixtures comprise a combination of two or more of a pH regulating admixture, a curing enhancer, an agglomeration reducer, a water-reducing admixture, a retarder, a corrosion inhibitor, a shrinkage reducer, a crack reducer, an air entrainer, a viscosity modifier, or combinations thereof.

17. The carbonatable-based cementitious material of claim 1, wherein the carbonatable material, the reducing agent, the uncarbonatable material, and the one or more admixtures are milled before exposure to CO₂.

18. The carbonatable-based cementitious material of claim 1, wherein the carbonatable-based cementitious material has a compressive strength of at least 1000 psi when cured.

19. A composite material comprising the carbonatable-based cementitious material of claim 1, and one or more aggregates.

20. A cement composition, comprising water and the carbonatable-based cementitious material of claim 1, wherein the ratio of water to carbonatable-based cementitious material is at least 0.15.

21. A method of carbonating a carbonatable material that comprises iron ore or slag, the method comprising using a reducing agent that comprises carbon or iron to thereby make cementitious binders via formation of FeCO₃, CaCO₃, MgCO₃, or combinations thereof.

22. A method of preparing a carbonatable-based cementitious material, comprising:
combining a carbonatable material, a reducing agent, an uncarbonatable material, and one or more admixtures, thereby forming the carbonatable-based cementitious material.

23. The method of claim 22, wherein the carbonatable material comprises magnetite (Fe₃O₄), hematite (Fe₂O₃), siderite (FeCO₃), geothite (FeO(OH)), ilmenite (FeTiO), limonite (FeO(OH))nH₂O, FeS₂ (Pyrite), Obsidian (Volcanic Glass), iron powder, heterosite, bernalite, greenalite, cubanite, annite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag, zinc and lead slag, mine tail, wollastonite and pseudowollastonite formed through sintering of limestone and sand, or combinations thereof.

24. The method of claim 22, wherein the reducing agent is present and comprises iron, lithium, carbon, hydrogen, iron impurities, coal, carbon black, activated carbon, iron-containing materials or carbon-containing materials, or combinations thereof.

25. The method of claim 22, wherein the uncarbonatable material comprises sand, gravel, or combinations thereof.

26. The method of claim 22, wherein the one or more admixtures comprise a pH regulating admixture, a curing enhancer, an agglomeration reducer, a water-reducing admixture, a retarder, a corrosion inhibitor, a shrinkage reducer, a crack reducer, an air entrainer, a viscosity modifier, or combinations thereof.

27. The method of claim 22, wherein one or more of the carbonatable material, the reducing agent, the uncarbonatable material, and the one or more admixtures are milled for a time of about 1 hour to about 50 hours.

28. The method of claim 22, wherein the carbonatable material is thermally treated at a temperature of about 25° C. to about 1000° C.

29. The method of claim 22, wherein the carbonatable material is cured with CO₂.

30. The method of claim 29, wherein curing the carbonatable material with CO₂ is performed at a temperature of about 25° C. to about 200° C.

31. The method of claim 29, wherein curing the carbonatable material with CO₂ is performed at a pressure of about 1 psi to about 200 psi.

32. The method of claim 29, wherein curing the carbonatable material with CO₂ is performed at a temperature of about 25° C. to about 200° C. and a pressure of about 1 psi to about 200 psi.
